(19) United States
(12) Patent Application Publication
(10) Pub. No.: US 2007/0223801 A1
(43) Pub. Date: Sep. 27, 2007

(54) Method and device for processing image data for automatic detection and/or segmentation of anatomical features from computed tomography pictures

(76) Inventor: Lutz Gundel, Erlangen (DE)

Correspondence Address: HARNESS, DICKEY & PIERCE, P.L.C., P.O.BOX 8910, RESTON, VA, 20195, US

(21) Appl. No.: 11/723,817

(22) Filed: Mar. 22, 2007

(30) Foreign Application Priority Data
Mar. 23, 2006 (DE) 10 2006 013 472.9

(51) Int. Cl. G06K 9/00; G06K 9/34

(52) U.S. Cl. 382/131; 382/181; 382/173

(57) ABSTRACT

A method and a device are disclosed for processing image data for automatic detection and/or segmentation of anatomical features from computed tomography pictures. In the case of an embodiment of the method, an image reconstruction procedure which exhibits a filter characteristic having an actual filter frequency response desired for a pictorial representation generates an image data record from measured data of a computed tomography picture of an examination area. A corrected image data record is obtained from the image data record with the aid of a correction filter and is subjected to an algorithm for automatic detection or segmentation of anatomical features in the examination area. The correction filter is obtained from the quotient of a desired filter frequency response, suitable for optimum automatic detection or segmentation, and the actual filter frequency response. Satisfactory results can be obtained in the automatic detection and/or segmentation of the image data with the aid of an embodiment of the method and/or the associated device, even with the non-optimum selection of the convolution core for the image reconstruction procedure.

### PRIORITY STATEMENT

The present application hereby claims priority under 35 U.S.C. §119 on German patent application number DE 10 2006 013 472.9 filed Mar. 23, 2006, the entire contents of which is hereby incorporated herein by reference.

### FIELD

Embodiments of the present invention generally relate to a method and/or a device for processing image data. For example, they may relate to a method and/or a device for processing image data for automatic detection and/or segmentation of anatomical features from computed tomography pictures. For example, in the case of such a method and/or device, an image reconstruction procedure that exhibits a filter characteristic having an actual filter frequency response desired for a pictorial representation may generate an image data record from measured data of a computed tomography picture of an examination area, and display it as an image, and automatic detection or segmentation of anatomical features in the examination area may be carried out starting from the image data record.

### BACKGROUND

Medical imaging is used to support patient diagnosis in the case of greatly differing diagnostic problems. It is true that an experienced user can identify diagnostically relevant salient features in the recorded image data, but there is a risk with as yet inexperienced users that such serial features are overlooked. It is known for the purpose of eliminating this problem to apply to the recorded image data records algorithms for automatic detection of anatomical features, for example lesions, also known under the term CAD (Computer Aided Detection). These algorithms are used to sift the image data records for specific structures that are characteristic of the anatomical features and/or lesions being sought. The result is displayed to the user so that he can reliably identify lesions or other anatomical features.

Similarly, algorithms for automatic segmentation and volumetric determination, that is to say measurement of the volume, of anatomical features in the image data records of computed tomography pictures are also known. The algorithms available to the user for automatic detection or segmentation of anatomical features are generally optimized for specific scan parameters of the computed tomography picture, and to reconstruction parameters for the image reconstruction procedure from the recorded measured data. If other parameters are used, there is a drop in the efficiency of algorithms. CAD algorithms exhibit a lower hit rate, the segmentation can fail, and the volumetric determination exhibits a corresponding error. Consequently, predefined scanning and reconstruction protocols suitable for these applications are available to the user.

In many instances, however, use is also made of other protocols in order to obtain an image quality desired by the user in the pictorial representation of the recorded computed tomography pictures. If, however, the aim in such a case is to carry out automatic detection and/or segmentation and, if appropriate, volumetric determination, the user makes recourse to the raw data in order to reconstruct these anew with the aid of the parameters optimized for automatic detection and/or segmentation, in particular with the aid of a suitable convolution core. If the raw data are no longer available, the disadvantages specified above must be accepted.

### SUMMARY

In at least one embodiment, a method and/or a device are provided, with the aid of which a satisfactory result in the automatic detection or segmentation and/or volumetric determination can be achieved even given an image reconstruction procedure that is not optimum for automatic detection or segmentation of anatomical features.

In the case of at least one embodiment of the proposed method, an image reconstruction procedure that exhibits a filter characteristic having an actual filter frequency response desired for a pictorial representation generates image data in the form of an image data record in a known way from the measured data of a computed tomography picture, and displays it as an image. The convolution core used for the image reconstruction procedure is optimized in this case for the desired image quality of the pictorial representation, or appropriately selected, and on the other hand therefore does not constitute the optimum convolution core for automatic detection or segmentation of anatomical features.

In the case of at least one embodiment of the present method, this image data record is now processed in the spatial domain or in the Fourier domain with an image filter in such a way that the algorithms subsequently applied to this image data record being operated upon or corrected and used for automatic detection and/or segmentation of anatomical features, in particular of lesions, attain better results. Anatomical features can in this case also be vessels, organs, bronchi, bones etc, for example, with reference to segmentation, and can also be stenoses, embolisms, malformations etc, for example, with reference to the detection.

The image filter denoted as correction filter in at least one embodiment of the present patent application is calculated from the quotient of a desired filter frequency response suitable for optimum automatic detection or segmentation and the actual filter frequency response. Any zero points occurring in the actual filter frequency response are interpolated in this case in order to obtain no divisions by zero. This interpolation can be performed with the aid of known interpolation techniques (polynomial, spline etc). The desired algorithm for automatic detection or segmentation and, if appropriate, volumetric determination of the relevant anatomical features in the examination area is subsequently applied to the image data record corrected in this way. The result for the user is that, on the one hand, he obtains a pictorial representation of the computed tomography picture with the desired image quality and that, on the other hand, he need not dispense with reliable automatic detection and/or segmentation and volumetric determination of anatomical features in the image data if the raw data are no longer available.

Processing the image data record with the aid of the correction filter can be performed both by applying the correction filter directly to the image data and by applying it to back calculated raw data that are obtained by inverse application of the image reconstruction carried out. These calculated raw data are subsequently subjected to renewed image reconstruction with the aid of an appropriately corrected convolution core, and this reconstruction then produces the corrected image data record. The corrected image data record is better suited in each case than the original image data for the subsequent CAD, segmentation or volumetric determination algorithms.

In an advantageous embodiment of the present method, two corrected image data records are obtained from the image data record with the aid of two different correction filters. The first image data record is optimized for automatic detection of the relevant anatomical features, while the second image data record is optimized by suitable selection of the second correction filter for automatic segmentation and, if appropriate, volumetric determination of the anatomical features. With the aid of the two corrected image data records, it is possible in this way to carry out simultaneously or sequentially both automatic detection of anatomical features and automatic segmentation and volumetric determination of the anatomical features. The two correction filters are respectively calculated, in turn, from the quotient of the respectively optimally suitable desired filter frequency response and the actual filter frequency response in order to obtain the filter cores required for the correction, either in the spatial domain or in the Fourier domain.

The proposed apparatus is designed for carrying out at least one embodiment of the method. In this case, the apparatus includes in a known way an image reconstruction module that produces an image data record from measured data of a computed tomography picture by way of an image reconstruction that exhibits a filter characteristic having an actual filter frequency response desired for a pictorial representation, and an image display module that displays the image data record as an image on a display device. This apparatus, generally integrated in an image computer, further has a correction module and a detection and/or segmentation module. The correction module calculates a corrected image data record from the image data record by means of a correction with the aid of the correction filter, and in so doing generates the correction filter from the quotient of a desired filter frequency response, suitable for optimum automatic detection or segmentation, and the actual filter frequency response. The respective filter frequency responses are either stored in a storage unit of the image computer, or are taken by the correction module via a database interrogation from a database connected to the image computer, this being done with the aid of convolution cores. The detection and/or segmentation module in this case includes one or more algorithms for automatic or semiautomatic detection and/or segmentation and volumetric determination of anatomical features in image data records that it applies to the corrected image data record obtained with the aid of the correction module. The result is displayed to the user in a known way.

### BRIEF DESCRIPTION OF THE DRAWINGS

The present method and the associated apparatus are explained again in more detail below with the aid of an example embodiment in conjunction with the drawing, in which the figure shows a schematic illustration of an example of an example of the present apparatus that is connected to the computer tomograph.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the term “and/or” includes any and all combinations of one or more of the associated listed items.

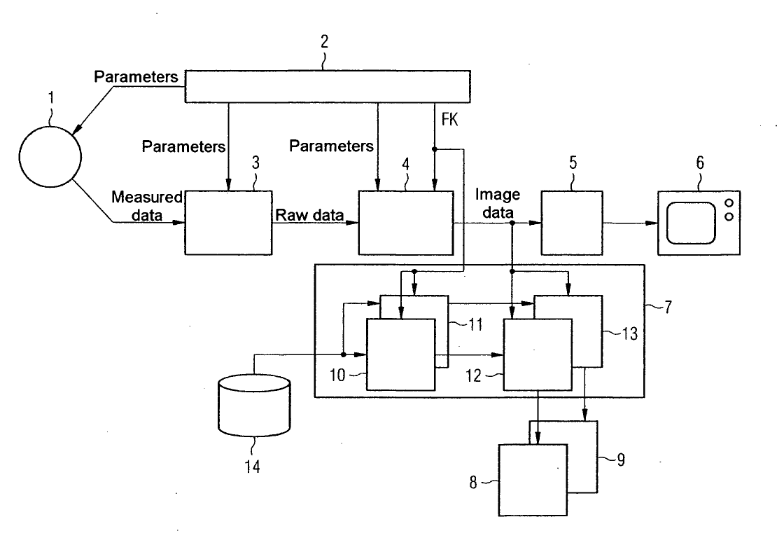

An example embodiment of the computer tomograph is represented in FIG. 1 by the schematically indicated gantry 1. When taking the computed tomography picture of the examination area of a patient, the user employs a user interface 2 to select the recording protocol, which is supplied to him with the desired image quality by the image result. Some parameters of this protocol are transferred to the gantry 1 as scanning parameters for controlling the computed tomography picture. Further parameters control the preprocessing 3 of the CT measured data, and the image reconstruction in the image reconstruction module 4. The parameters transferred to the image reconstruction module 4 also comprise the convolution core FK selected for the image reconstruction. This convolution core is simultaneously passed to the correction module 7 of an embodiment of the present apparatus.

The image data are reconstructed in the image reconstruction module 4 on the basis of the selected protocol or convolution core. The image data record is subsequently displayed as an image to the user on a monitor 6 by the image display module 5. If, for example, a smoothing convolution core has been used, this convolution core is not suitable for automatic detection or segmentation of lesions in the image data. The image data are therefore processed in the correction module 7 of the present apparatus with the aid of a suitable correction filter in such a way that the subsequent algorithms yield optimum results in the given circumstances. The correction or filter cores 10, 11 required to this end are determined from the quotient of desired and actual filter frequency responses. The conversion of an excessively hard filter core into a softer core raises no problems in this case. In the converse case, the conversion from an excessively soft core, as in the present case, into a harder core cannot be carried out by simply forming a quotient. The zero points in the actual filter frequency response would lead in this case to divisions by zero and are therefore not compensated by suitable interpolations in the frequency response.

In the present example embodiment, a correction core 10 is calculated for optimum automatic detection, and a correction core 11 is calculated for optimum automatic segmentation. The corresponding desired frequency responses are retrieved by the correction module 7 from a database 14 in which these frequency responses or filter cores are stored. Subsequently, the corrections 12, 13 of the image data record are performed with the aid of these correction cores 10, 11 in the correction module 7. The two corrected image data records thereby obtained are subsequently subjected in the detection module 8 to an algorithm for automatic detection of lesions, and in the segmentation module 9 to an algorithm for automatic segmentation and volumetric determination of the lesions. Examples of suitable algorithms are to be found in the specialist literature.

Of course, the corrections with the aid of the correction cores can also be carried out using raw data that are obtained by back calculation from the image data, that is to say by applying the image reconstruction inversely. The correction of the convolution cores is then performed in these calculated raw data. The subsequent renewed image reconstruction then leads directly to the corrected image data.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for processing image data for at least one of automatic detection and segmentation of anatomical features from computed tomography pictures, the method comprising:
generating, via an image reconstruction procedure that exhibits a filter characteristic including an actual filter frequency response desired for a pictorial representation, an image data record from measured data of a computed tomography picture of an examination area;
obtaining, with the aid of a correction filter, a corrected image data record from the image data record; and
subjecting the corrected image data record to an algorithm for at least one of automatic detection and segmentation of anatomical features in the examination area, the correction filter being obtained from a quotient of a desired filter frequency response, suitable for at least one of optimum automatic detection and segmentation, and the actual filter frequency response.

2. The method as claimed in claim 1, wherein two corrected image data records are obtained, from the image data record with the aid of two different correction filters, of which a first image data record is subjected to an algorithm for automatic detection of anatomical features, and a second image data record is subjected to an algorithm for automatic segmentation of anatomical features in the examination area, the first of the two correction filters being obtained from the quotient of a desired filter frequency response, suitable for optimum automatic detection, and the actual filter frequency response, and the second of the two correction filters being obtained from the quotient of a desired filter frequency response, suitable for optimum automatic segmentation, and the actual filter frequency response.

3. The method as claimed in claim 1, wherein zero points are interpolated in the actual filter frequency response before the formation of the quotient, in order to prevent a division by zero.

4. A device for processing image data for at least one of automatic detection and segmentation of anatomical features from computed tomography pictures, the device comprising:
an image reconstruction module to, by employing an image reconstruction procedure that exhibits a filter characteristic including an actual filter frequency response desired for a pictorial representation, generate an image data record from measured data of a computed tomography picture;
an image display module to display the image data record as an image on a display device;
a correction module to calculate a corrected image data record from the image data record with the aid of a correction filter; and
a module to subject the corrected image data record to an algorithm for at least one of automatic or semiautomatic detection and automatic or semiautomatic segmentation of anatomical features in the examination area, the correction module being designed to generate the correction filter from a quotient of a desired filter frequency response, suitable for at least one of optimum automatic detection and segmentation, and the actual filter frequency response.

5. The device as claimed in claim 4, wherein the correction module is designed to calculate two corrected image data records from the image data record with the aid of two different correction filters, in which case the correction module is designed to generate the first of the two correction filters from the quotient of a desired filter frequency response, suitable for optimum automatic detection, and the actual filter frequency response, and to generate the second of the two correction filters from the quotient of a desired filter frequency response, suitable for optimum automatic segmentation, and the actual filter frequency response.

6. The method as claimed in claim 2, wherein zero points are interpolated in the actual filter frequency response before the formation of the quotient, in order to prevent a division by zero.

7. A computer readable medium including program segments for, when executed on a computer device, causing the computer device to implement the method of claim 1.

8. A device for processing image data for at least one of automatic detection and segmentation of anatomical features from computed tomography pictures, the device comprising:
means for generating, via an image reconstruction procedure that exhibits a filter characteristic including an actual filter frequency response desired for a pictorial representation, an image data record from measured data of a computed tomography picture of an examination area;
means for obtaining, with the aid of a correction filter, a corrected image data record from the image data record; and
means for subjecting the corrected image data record to an algorithm for at least one of automatic detection and segmentation of anatomical features in the examination area, the correction filter being obtained from a quotient of a desired filter frequency response, suitable for at least one of optimum automatic detection and segmentation, and the actual filter frequency response.
